(19) United States
(12) Patent Application Publication
(10) Pub. No.: US 2026/0342034 A1
(43) Pub. Date: Oct. 29, 2026

(54) HOLLOW CORE FIBER SYSTEM WITH SOLID CORE FIBER ASSISTED MONITORING

(71) Applicant: HUAWEI TECHNOLOGIES CO., LTD., Shenzhen (CN)

(72) Inventors: Zhiping JIANG, Kanata (CA); Qingyi GUO, Kanata (CA); Choloong HAHN, Kanata (CA)

(73) Assignee: HUAWEI TECHNOLOGIES CO., LTD., Shenzhen (CN)

(21) Appl. No.: 19/282,708

(22) Filed: Jul. 28, 2025

Related U.S. Application Data
(60) Provisional application No. 63/794,848, filed on Apr. 25, 2025.

(51) Int. Cl. H01S 3/067; G01M 11/00

(52) U.S. Cl. CPC H01S 3/06729; G01M 11/335; H01S 3/06716

(57) ABSTRACT

An optical fiber system (OFS) is presented. The OFS includes a plurality of segments of hollow core fiber (HCF) interleaved with a plurality of segments solid core fiber (SCF) or SCF components. The segments of HCF and SCF are physically connected to each other and optically coupled to define an optical transmission path. The OFS provides advantages of using hollow core fiber (HCF), such as low latency and high power handling and uses inherent properties of SCF to allow for longitudinal performance monitoring of the optical transmission path.

### CROSS-REFERENCE TO RELATED APPLICATIONS

This application claims the benefit of U.S. Provisional Application No. 63/794,848, filed on Apr. 25, 2025, and titled “HOLLOW CORE FIBER SYSTEM WITH SOLID CORE FIBER ASSISTED MONITORING”, the entire content of which is hereby incorporated by reference.

### FIELD OF THE DISCLOSURE

The present disclosure relates generally to optical fiber communication systems, and in particular to hollow core fiber arrangements and to methods for monitoring such arrangements.

### BACKGROUND

Optical fibers are common components in modern high-speed communication networks. While conventional systems often use solid core fibers (SCF), where light propagates through solid glass or plastic materials, alternative fiber types such as Hollow Core Fiber (HCF) have been developed. HCF guides light within a hollow core, which may be filled with air or other gas. This structure results in HCF having different optical properties compared to SCF, including potentially low optical nonlinearity and distinct dispersion characteristics.

The operational management of optical networks often involves monitoring the transmission path to assess its condition and the quality of the signals it carries. Many conventional monitoring techniques applied in SCF-based systems rely on interactions between the propagating light and the fiber medium itself. However, the structural nature of HCF may cause reduced interaction between the guided light and any solid material present in the HCF compared to SCF. This may result in low intrinsic optical nonlinearity and diminished levels of Rayleigh backscattering within the HCF core. These inherent physical properties of HCF may pose challenges when attempting to apply certain conventional fiber optic monitoring approaches directly to HCF segments.

Some techniques have explored deploying an SCF path in parallel with an HCF path and monitoring the SCF to allow for detection of physical events like fiber cuts along the route. Such approaches, however, do not generally yield information regarding the quality of the optical signal as it propagates within the HCF segment.

Therefore, there is a need for a hollow core fiber system with solid core fiber assisted monitoring and related systems and methods that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure relates to HCF arrangements and to monitoring such arrangements, which may be part of optical fiber communication systems. Some implementations described herein pertain to methods, systems, apparatus, and hybrid fiber optic cable structures that employ solid core fiber (SCF) segments connected in series with HCF segments to facilitate performance monitoring.

In a first aspect of the present disclosure, there is provided a fiber optic cable that comprises a hollow core fiber (HCF) segment and a solid core fiber (SCF) segment secured to the HCF segment and optically coupled to the HCF segment. The SCF segment has a material with at least one physical property that causes an optical signal propagating through the material to interact with the material to generate a modified optical signal.

In some implementations, the at least one physical property may include at least one of: A) an intensity-dependent refractive index that causes optical nonlinearity; B) a fluctuation of a density of the material that causes Rayleigh backscattering; C) a wavelength-dependent refractive index that causes dispersion of the optical signal; and D) an absorption characteristic of the material that causes attenuation of the optical signal. In a second aspect of the present disclosure, there is provided a fiber optic cable that comprises: a plurality of hollow core fiber (HCF) segments; and a plurality of solid core fiber segments interleaved with the plurality of HCF segments to form a series of alternating HCF and SCF segments. The plurality of HCF segments are secured to the plurality of SCF segments and are optically coupled to the plurality of SCF segments.

In some implementations, the plurality of HCF segments may be configured to have an HCF mode field diameter (MFD) and the plurality of SCF segments may be configured to have an SCF MFD that substantially matches the HCF mode field diameter.

In some implementations, each HCF segment of the plurality of HCF segments has a respective HCF length, each SCF segment of the plurality of SCF segments has a respective SCF length, and the fiber optic cable has a length equal to the sum of the HCF lengths and the SCF lengths.

In some implementations, at least one SCF segment of the plurality of SCF segments may comprise a respective active optical device.

In some embodiments, the active optical device may be an erbium doped fiber amplifier.

In a third aspect of the present disclosure, there is provided an optical fiber that comprises: a plurality of segments of hollow core fiber (HCF); and a plurality of segments of solid core fiber (SCF) interleaved with the plurality of segments of HCF to form a series of alternating segments of HCF and SCF. The plurality of segments of HCF is fused to the plurality of segments of SCF and optically coupled to the plurality of segments of SCF. The plurality of segments of HCF and the plurality of segments of SCF define a continuous optical path for light to propagate therethrough.

In a fourth aspect of the present disclosure, there is provided an optical fiber system that comprises: a plurality of segments of hollow core fiber (HCF); and a plurality of solid core fiber (SCF) components interleaved with the plurality of segments of HCF to form a series of alternating segments of HCF and SCF components. The plurality of segments of HCF are fused to the plurality of SCF components and optically coupled to the plurality of SCF components. The plurality of segments of HCF and the plurality of SCF components define a continuous optical path for light to propagate therethrough.

In some implementations, the plurality of SCF components may include at least one of: segments of SCF, an electrooptical device having at least one of an input SCF segment and an output SCF segment; an electromechanical device having at least one of an input SCF segment and an output SCF segment; a wavelength multiplexing or demultiplexing device having at least one of an input SCF segment and an output SCF segment; and an optical resonator device having at least one of an input SCF segment and an output SCF segment.

In some implementations, the electrooptical device may include a fiber amplifier.

In some implementations, the electromechanical device may be a wavelength selective switch.

In some embodiments, the electromechanical device may include a micro-electromechanical system.

In a fifth aspect of the present disclosure, there is provided a method of characterizing the optical fiber system described above in relation to the fourth aspect of the present disclosure. The method comprises: transmitting a plurality of wavelengths through the optical fiber system described in relation to the fourth aspect. The plurality of wavelengths each have associated thereto a same nominal intensity. The method further comprises: selecting a test wavelength from the plurality of wavelengths; increasing the intensity of the test wavelength to a pre-determined level; performing a power profile estimation or a longitudinal performance estimation of the optical fiber system, at the test wavelength; and decreasing the intensity of the test wavelength to the nominal intensity.

In a sixth aspect of the present disclosure, there is provided a method of characterizing the optical fiber system described above in relation to the fourth aspect of the present disclosure. The method comprises: transmitting a plurality of wavelengths through the optical fiber system described in relation to the fourth aspect. The method further comprises transmitting a test wavelength through the optical fiber system described in relation to the fourth aspect, the test wavelength being distinct from the plurality of different wavelengths, the test wavelength having an intensity at least 10 times that of the nominal intensity; and performing a power profile estimation or a longitudinal performance estimation of the optical fiber system, at the test wavelength.

According to another aspect, an apparatus may be provided, where the apparatus includes: a memory, configured to store a program; a processor, configured to execute the program stored in the memory, and when the program stored in the memory is executed, the processor is configured to perform one or more of the methods and systems described herein.

According to another aspect, a (e.g., non-transitory) computer readable medium may be provided, where the computer readable medium stores program code executed by a device and the program code is used to perform one or more of the methods and systems described herein.

According to another aspect, there may be provided a computer program, or computer program product, comprising stored thereon statements and/or instructions which, when executed by a computer processor perform one or more methods described herein.

According to another aspect, an apparatus or system is provided, where the apparatus includes modules configured to perform one or more methods described herein. According to another aspect, another apparatus is provided that includes computing electronics or processing circuitry and is configured to perform one or more methods described herein.

According to another aspect, a chip may be provided, where the chip includes a processor and a data interface, and the processor reads, by using the data interface, an instruction stored in a memory, to perform one or more of the methods described herein. Aspects may further include the memory. Additionally or alternatively, the chip may include electronics hardware such as digital circuits, analog circuits, or a combination thereof, which are configured to implement the operations as described herein.

Implementations have been described above in conjunctions with aspects of the present disclosure upon which they can be implemented. Those skilled in the art will appreciate that implementations may be implemented in conjunction with the aspect with which they are described, but may also be implemented with other implementations of that aspect. When implementations are mutually exclusive, or are otherwise incompatible with each other, it will be apparent to those skilled in the art. Some implementations may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates a point-to-point optical communication system architecture.

FIG. 2 illustrates an exemplary longitudinal performance monitoring (LPM) or power profile estimation (PPE) curve showing monitored power versus accumulated chromatic dispersion.

FIG. 3 illustrates several exemplary configurations for incorporating SCF segments in series with HCF segments, according to an implementation of the present disclosure.

FIG. 4 illustrates simulated PPE results for an SCF-assisted HCF system, according to an implementation of the present disclosure.

FIG. 5 illustrates an exemplary experimental setup used for SCF-assisted monitoring, including components for HCF emulation, according to an implementation of the present disclosure.

FIG. 6 is a graph comparing experimental and simulated PPE results obtained using a setup similar to that of FIG. 5, according to an implementation of the present disclosure.

FIG. 7 is a graph illustrating estimated differential group delay (DGD) results obtained from SCF-assisted monitoring using a setup similar to that of FIG. 5, according to an implementation of the present disclosure.

FIG. 8 is a flowchart illustrating a method for monitoring an optical fiber transmission path, according to an implementation of the present disclosure.

FIG. 9A is a block diagram illustrating a hardware apparatus or processing system, according to an implementation of the present disclosure.

FIG. 9B is a block diagram illustrating another hardware apparatus, according to an implementation of the present disclosure.

FIG. 9C is a block diagram illustrating another hardware apparatus including functional units, according to an implementation of the present disclosure.

It will be noted that throughout the appended drawings, like features are identified by like reference numerals.

### DETAILED DESCRIPTION

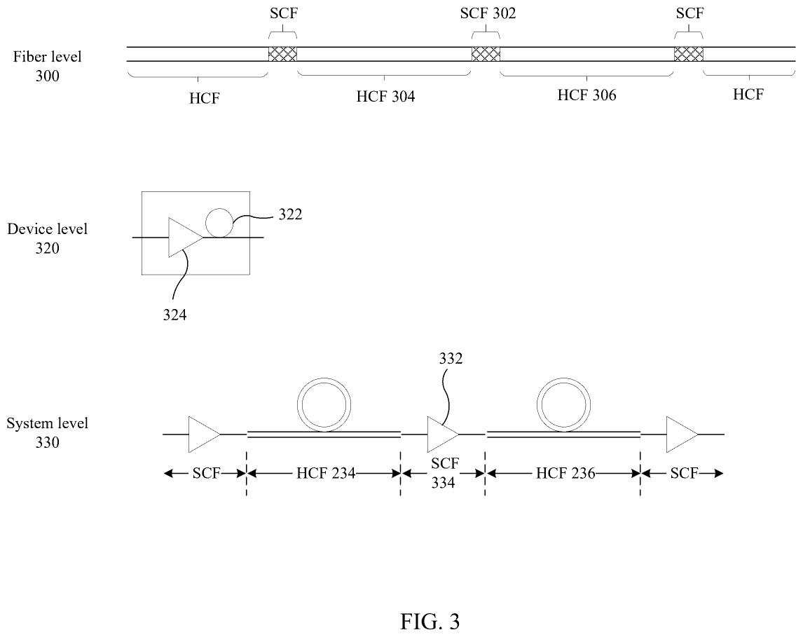

Implementations described herein generally relate to enabling or improving the monitoring of optical signals propagating through transmission paths including hollow core fiber (HCF), potentially by using segments of solid core fiber (SCF) incorporated in series within the path. Examples of how SCF segments may be incorporated at different levels (fiber, device, system) are illustrated in FIG. 3. This series arrangement may allow for leveraging physical properties inherent to the SCF segments to facilitate monitoring of the overall path.

The monitoring approaches described may use interactions between the propagating optical signal and physical properties of the SCF segments, such as their optical nonlinearity or Rayleigh backscattering. By performing an analysis based on these interactions occurring within the SCF segments, performance characteristics related to the propagation of an optical signal along the transmission path, including through the HCF segments, may be determined.

HCF is a type of optical fiber that guides light through a hollow, air-filled (gas-filled) core, rather than a solid glass or plastic core, offering advantages like low dispersion, low nonlinearity, and high laser damage threshold.

However, HCF also has issues. Without a solid core, there is very small nonlinearity and Rayleigh backscattering. Fiber system monitoring techniques that rely on these phenomena do not perform as well as with solid core fibers.

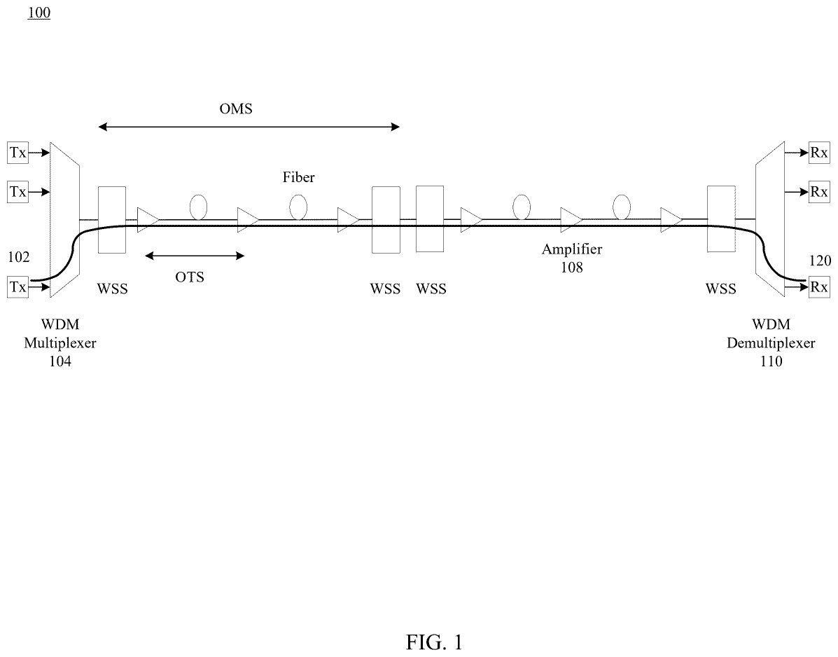

FIG. 1 shows a typical point-to-point fiber communication system 100, which is free of HCF. The communication system 100 comprises transmitters (Tx) 102, a wavelength division multiplexing (WDM) multiplexer (mux) 104 to combine transmitted channels, Wavelength Selective Switches (WSS) for routing channels and/or equalizing channel power, and optical amplifiers 108 for compensating losses from the transmission fiber. The system 100 further includes a WDM demultiplexer (demux) 110 for separating channels and receivers (Rx) 120 for receiving channel information. The transmission path includes optical transport sections (OTS) and optical multiplex sections (OMS). There may be many other components required for proper operation but not shown in FIG. 1.

Longitudinal performance monitoring (LPM) is a powerful performance monitoring technology in coherent fiber communication systems. LPM is a receiver-side (Rx-side) monitoring technology and uses the received signal only to retrieve the signal's characteristics along the entire link (e.g., from Tx 102 to Rx 120), including power profile, polarization dependent loss (PDL), differential group delay (DGD), filtering effects, etc. What can be retrieved is not just the accumulated (overall) characteristic value, but also the characteristic value at each location along the signal's path (hence the term “longitudinal”). As an example, the power evolution along the fiber link provides relevant information about the fiber loss. Loss anomalies may be detected. The monitoring of other parameters (characteristics) may provide relevant information for the signal's quality of transmission (QoT).

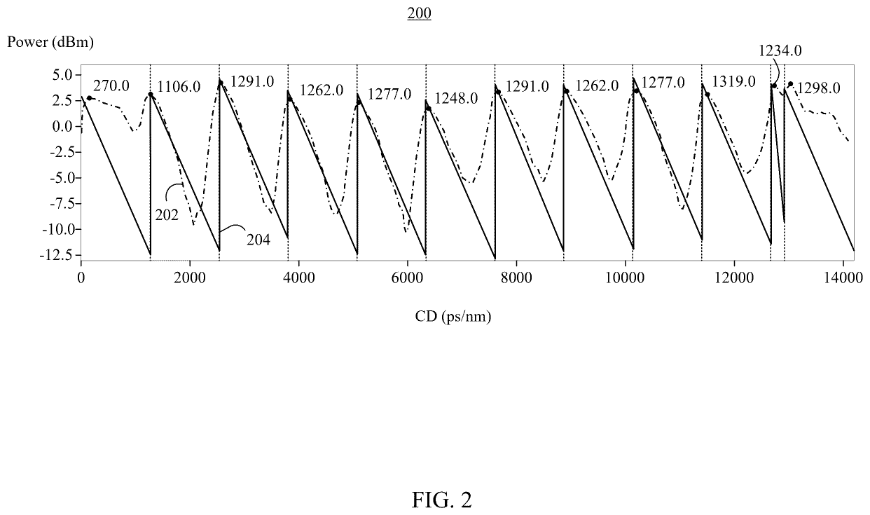

FIG. 2 plots an exemplary LPM curve 200. The x-axis represents the accumulated Chromatic Dispersion (CD) in picoseconds per nanometer (ps/nm), which is proportional to distance, and the y-axis represents the monitored power in decibels relative to 1 milliwatt (dBm). One curve (e.g., the dashed/dotted line 202 in the example figure) represents the LPM monitored power, while another curve (e.g., the solid line 204 in the example figure) represents the true power calculated using the fiber loss. As the signal propagates down the fiber link, it experiences fiber loss, hence the power drop shown. Then, at the location of an amplifier the power is boosted by the amplifier, leading to a sharp power increase. The black dots in FIG. 2 indicate the locations and powers at the beginning of each span. The numbers noted next to these dots represent the difference in CD relative to the previous peak CD location, and therefore indicate the calculated per-span CD (i.e., the CD for each span).

LPM relies on fiber nonlinearity. In HCF systems, fiber nonlinearity may be negligible; therefore, LPM may not work effectively anymore.

SCFs have relatively strong Rayleigh backscattering due to their material density fluctuations. Rayleigh backscattering is used by Optical Time Domain Reflectometry (OTDR) or Distributed Acoustic Sensing (DAS) to monitor fiber loss and the environment. With greatly reduced Rayleigh backscattering in HCF, the effectiveness of OTDR and DAS is therefore greatly reduced.

Some approaches have considered using SCF in parallel with HCF. For instance, one approach involves monitoring an SCF that co-exists (is co-extensive) in parallel with the HCF. By monitoring the SCF, detection of events like a fiber cut may be possible. Such solutions, however, may be limited in that they typically do not provide monitoring of the optical signal's quality or performance characteristics as it propagates through the HCF.

Implementations described in the present disclosure relate generally to systems, methods, apparatus, and fiber structures that may enable performance and signal quality monitoring in optical communication systems employing HCF.

Implementations include the use of SCF segments connected in series with HCF segments within the transmission path. In some implementations, these SCF segments may be strategically placed to assist in the performance monitoring of the optical signal propagating through the HCF system. By leveraging physical properties (such as optical nonlinearity or Rayleigh backscattering) that are substantially greater in the SCF segments than in the HCF segments, interactions between the propagating optical signal and the SCF segments can be analyzed to determine performance characteristics related to the entire path, including through the HCF segments.

In some embodiments, an SCF segment is secured to and optically coupled with an HCF segment. In some embodiments, the physical properties of the SCF segment's material cause a portion of an optical signal propagating through the material to interact with the material, which in turn generates a modified optical signal. This modified optical signal, which carries information about the interaction, can then be analyzed to determine the performance characteristics. The term “secured,” as used herein, refers to any suitable means of physically joining two optical fiber segments to ensure a stable connection. This includes, but is not limited to, being fused together (e.g., through fusion splicing), mechanically spliced, or connected via optical connectors. The term is intended to cover any means of creating a fixed, functional junction.

Such SCF-assisted monitoring may allow for performance monitoring in HCF systems where direct monitoring is challenging. Implementations may enable the determination of various signal quality metrics. The approaches described herein may be applicable to various optical communication system architectures or scenarios, including point-to-point systems such as the one illustrated in FIG. 1, as well as potentially other network types like Passive Optical Networks (PON). Implementations encompass methods of performing the monitoring, communication systems incorporating the hybrid path and monitoring capabilities, apparatus (like monitoring subsystems or configured receivers) for performing the analysis, and the hybrid fiber optic cable structure itself.

FIG. 3 illustrates different configurations that incorporate SCF segments in series with HCF segments within a transmission path to facilitate SCF-assisted monitoring in HCF systems. Various approaches may be implemented.

As shown in the fiber level configuration 300, one or more SCF segments 302 may be positioned or inserted between HCF segments (e.g., HCF 304 and HCF 306) along the length of the fiber path to form a fiber or a fiber optic cable. The SCF segment 302 may be relatively short compared to the HCF segments 304 and 306. This arrangement places SCF segments 302 in series with HCF segments 304 and 306. The SCF segments can be said to be interleaved with the HCF segments.

In some embodiments, a plurality of HCF segments and a plurality of SCF segments are interleaved to form a series of alternating HCF and SCF segments. In some embodiments, the plurality of HCF segments are secured to the plurality of SCF segments and are optically coupled to the plurality of SCF segments, which may provide for a continuous optical path. In some embodiments, the plurality of HCF segments are fused to the plurality of SCF segments and are optically coupled to the plurality of SCF segments, thereby defining a continuous optical path for light to propagate therethrough.

Alternatively, as shown in the device level configuration 320, an SCF segment 322 may be included within or added adjacent to another optical component. For example, SCF segment 322 may be positioned after an optical amplifier, such as a semiconductor optical amplifier (SOA) 324. In these cases, the SCF may be referred to as or be part of an SCF component. An SCF component may include one or more of: a segment of SCF, an SOA 324, an electrooptical device, an electromechanical device, a wavelength multiplexing or demultiplexing device, an optical resonator device or any other suitable type of device that has at least one of an SCF input and an SCF output. In specific implementations, the electrooptical device may include a fiber amplifier or a liquid crystal display device. In other implementations, the electromechanical device may include a wavelength selective switch or a micro-electromechanical system.

Further, as illustrated in the system level configuration 330, SCF segments may be used at system nodes, such as amplification nodes incorporating amplifiers 332, which are typically located between longer transmission HCF spans (e.g., HCF 234 and HCF 236). At such nodes, an SCF segment 334 might already be present as part of an existing optical component (for example, an active optical device, such as erbium-doped fiber (EDF) within an EDFA, may function as the SCF segment). Alternatively, an SCF segment may be added at these nodes, connected in series with the HCF spans 234, 236 and potentially adjacent to the amplifier 332, for the purpose of enabling monitoring.

As will be understood by the skilled worker, the geometry of each SCF or HCF segment and the materials that make up the SCF and HCF segments have an effect on the mode field diameter of an optical signal propagating through the SCF and HCF segments. The diameter and the materials of the SCF and HCF segments may be selected such that the mode field diameter for all the segments is substantially the same. In some implementations where a plurality of HCF segments and a plurality of SCF segments form the fiber optic cable, the plurality of HCF segments are configured to have an HCF MFD and the plurality of SCF segments are configured to have an SCF MFD that substantially matches the HCF MFD. In these configurations, each HCF segment of the plurality of HCF segments may have a respective HCF length, and each SCF segment of the plurality of SCF segments may have a respective SCF length. The total fiber optic cable may then have a length equal to a sum of the HCF lengths and the SCF lengths.

A general approach in these implementations is the use of the SCF segments, whether they are pre-existing within components or specifically added to the path, to enable performance monitoring within systems predominantly composed of HCF. Analyzing the interaction between a propagating optical signal and the physical properties of these SCF segments allows for determination of performance characteristics related to the signal's propagation through the transmission path, including the HCF segments. The properties of the SCF segments that give rise to measurable physical parameters include the composition of the materials comprised in SCF segments. These materials may produce a nonlinear, intensity-dependent refractive index. A fluctuation of a density of the materials comprised in the SCF segments may cause Rayleigh backscattering. A wavelength-dependent refractive index of the materials may cause dispersion of the optical signal. Absorption characteristics of the materials may cause an attenuation of the optical signal.

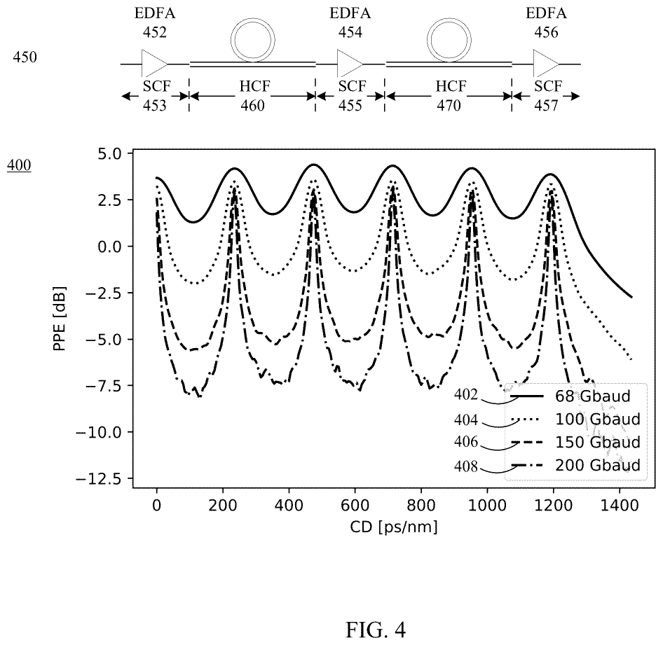

FIG. 4 illustrates simulated results for power profile estimation (PPE)/LPM, in an exemplary HCF system that comprises SCF, according to an implementation of the present disclosure. The upper part of FIG. 4 shows a schematic 450 illustrating a portion of the simulated optical path. This path includes HCF spans (e.g., HCF 460, HCF 470) connected in series with SCF segments (e.g., SCF 453, SCF 455, SCF 457) and optical amplifiers, EDFAs in this example (e.g., EDFA 452, EDFA 454, EDFA 456). In the simulation corresponding to graph 400, the system modeled includes multiple HCF spans (e.g., six 80 km spans), with short SCF segments (e.g., 90 m) assumed present at each amplifier output or before each HCF span. The graph 400 plots the simulated PPE results (PPE level in decibels (dB) on the y-axis) versus accumulated chromatic dispersion (CD in ps/nm on the x-axis, which is proportional to distance). Different curves show results for different signal baud rates, such as 68 giga baud (Gbaud) (402), 100 Gbaud (404), 150 Gbaud (406), and 200 Gbaud (408). The distinct peaks observable in the PPE curves correspond to the locations of the amplifiers/SCF segments (e.g., 452/453, 454/455, 456/457), demonstrating that the SCF-assisted PPE/LPM analysis can potentially resolve the power profile along the hybrid link via simulation.

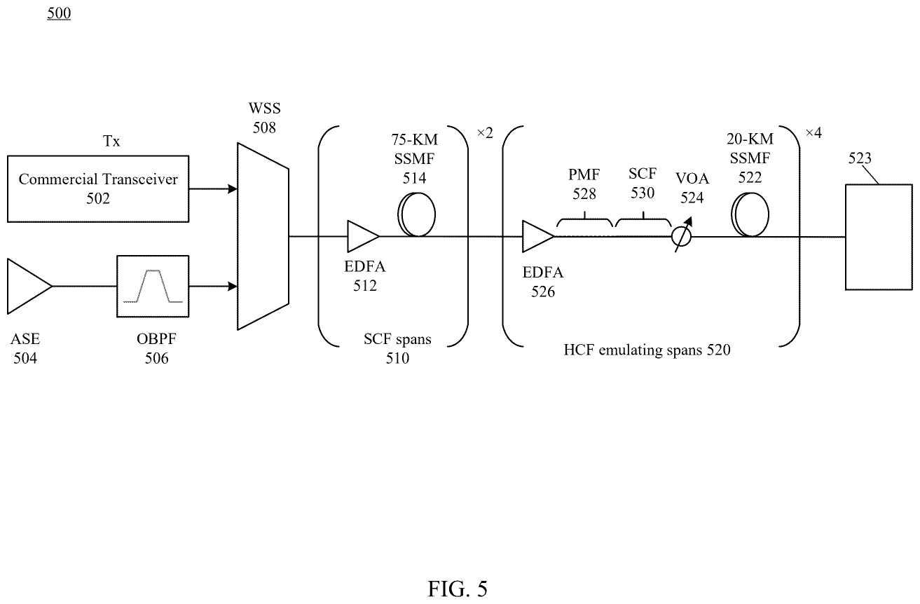

FIG. 5 illustrates an experimental setup 500 used for the SCF-assisted monitoring approach, according to an implementation of the present disclosure. The setup 500 includes components such as a commercial optical transceiver 502, potentially an Amplified Spontaneous Emission (ASE) noise source 504 with an Optical Bandpass Filter (OBPF) 506, and a WSS 508. The transmission path comprises two initial SCF spans 510, each including 75-km of Standard Single Mode Fiber (SSMF) 514 and an EDFA 512. These are followed by four HCF emulating spans 520 where HCF characteristics were emulated in spans 520. Each emulating span 520 includes a length of SSMF (e.g., 20-km SSMF 522) connected to a Variable Optical Attenuator (VOA) 524. The VOA 524 is set to an attenuation value (e.g., 30 dB) to emulate the low nonlinearity typical of HCF (which may be around 30 dB lower than that of SCF). A relatively shorter length of SSMF 522 (e.g., 20 km) is used compared to the SCF spans 510 (e.g., 75 km) to approximate the total dispersion of an equivalent HCF span, given their different dispersion coefficients (e.g., HCF ~3 ps/nm/km vs. SSMF ~17 ps/nm/km). Each HCF emulating span 520 also includes an SCF segment 530 connected in series (shown here between the VOA 524 and an EDFA 526). A Polarization Maintaining Fiber (PMF) segment 528 is also included in this experimental setup, connected between EDFA 526 and SCF 530, which may introduce controllable Differential Group Delay (DGD) for testing DGD monitoring capabilities. A coherent receiver 523 is provided at the output of last HCF emulating span. The coherent receiver 523 is configured to perform digital signal processing (DSP)—based operations on the optical signal received at aforementioned output, to obtain longitudinal performance metric values of the experimental setup. In the context of the present disclosure, performance metrics of an optical transmission system (e.g., the aforementioned experimental setup, a span of a network, of a fiber, etc.) are measurable parameters that may be used to evaluate the quality/reliability of the optical transmission system. The performance metrics may include optical power, generalized optical signal-to-noise ratio, differential group delay (DGD), polarization dependent gain (PDG), polarization dependent loss (PDL), multipath interference (MPI), or any other suitable parameter. This setup may demonstrate a practical implementation of a hybrid path (using emulated HCF) including SCF segments (510 and 530) for testing the monitoring methods.

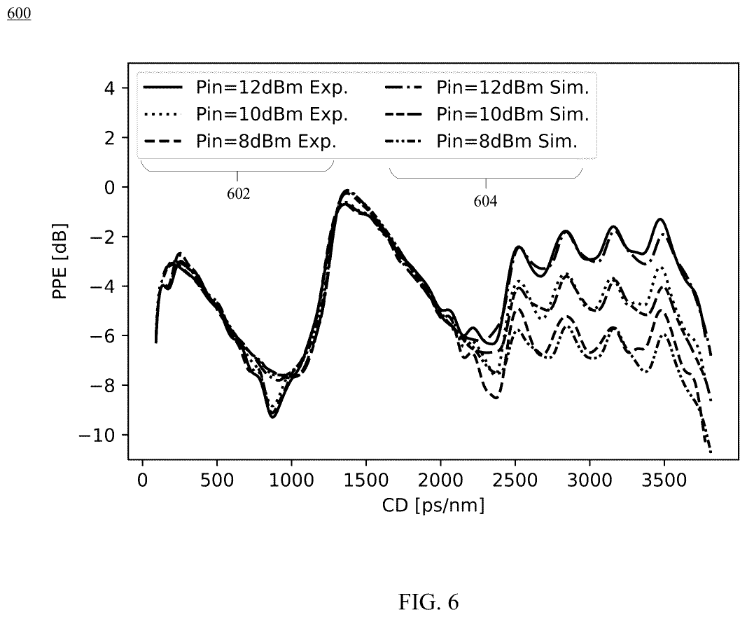

FIG. 6 illustrates a graph 600 comparing experimental results obtained using the setup of FIG. 5 with corresponding simulation results. The graph 600 plots PPE (in dB, y-axis) versus accumulated CD (in ps/nm, x-axis). As shown, the graph shows experimental data plots 602 and simulation data plots 604, for various input power (Pin) applied into the HCF emulated spans (e.g., 8 dBm, 10 dBm, 12 dBm), where the input power of the first two SCF spans is fixed to 0 dBm. The close agreement observed between the experimental data plots 602 and the simulation data plots 604 may verify the SCF-assisted PPE/LPM monitoring concept, which further indicates that the analysis performed based on interactions within the SCF segments may provide results consistent with expected behavior.

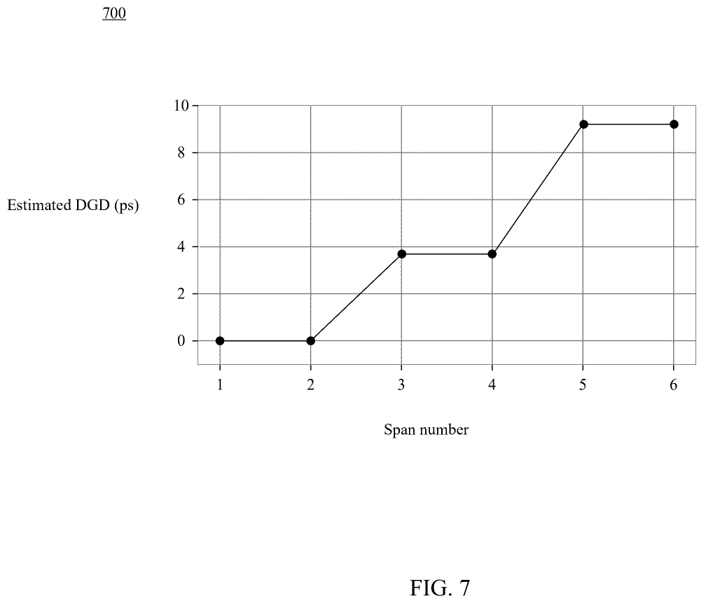

The monitoring techniques enabled by the SCF segments can potentially determine specific signal impairments. Polarization Mode Dispersion (PMD), resulting in DGD, can be an issue in HCF systems. As mentioned, the setup in FIG. 5 included PMF segments 528 to cause DGD. FIG. 7 illustrates a graph 700 showing the estimated DGD (in picoseconds (ps), y-axis) determined for each span number (x-axis) using the SCF-assisted analysis performed based on the setup 500 of FIG. 5. The ability to estimate the DGD demonstrates that the disclosed approach may allow for monitoring performance characteristics (e.g., DGD).

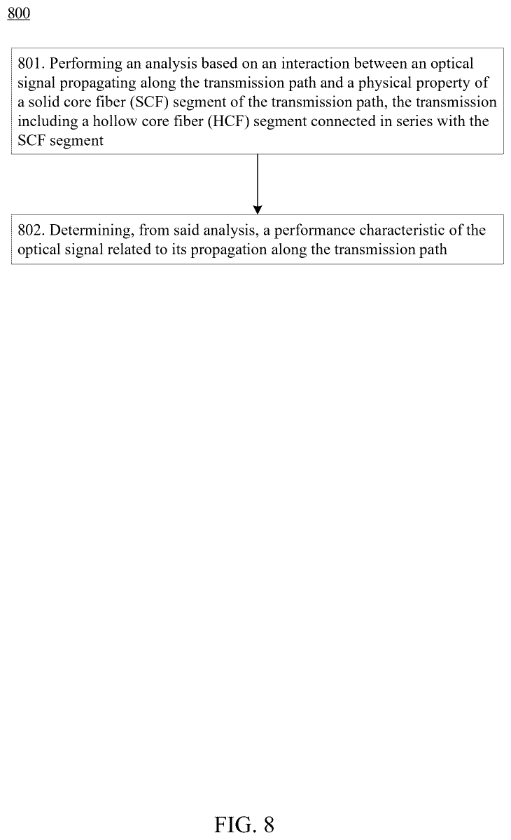

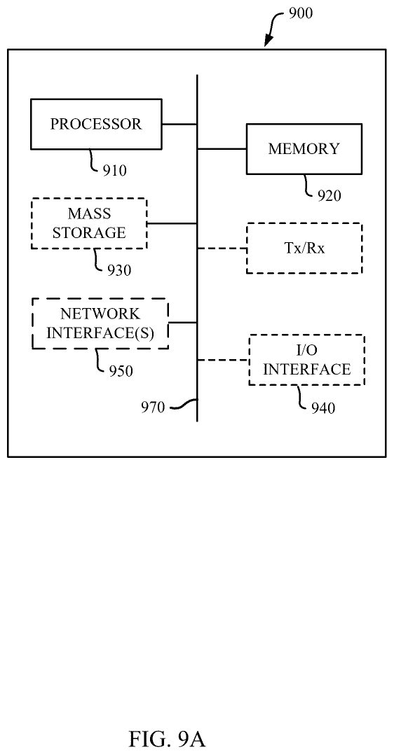

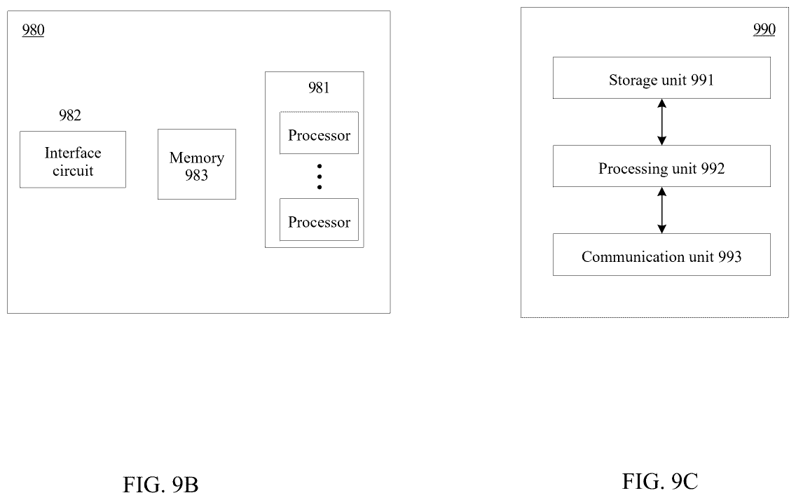

FIG. 8 is a flowchart illustrating an exemplary method 800 for monitoring an optical fiber transmission path according to an implementation of the present disclosure. The method 800 may be performed, for example, by a monitoring subsystem or apparatus associated with the transmission path (such as the system 100 shown in FIG. 1, potentially implemented within or coupled to receiver 120 or using architectures like those shown in FIGS. 9A-C). The transmission path includes at least one HCF segment connected in series with at least one SCF segment (as illustrated, for example, in FIG. 3).

The method 800 includes, at 801, performing an analysis based on an interaction between an optical signal propagating along the transmission path and a physical property of the SCF segment. As described herein, the optical signal interacts differently with the SCF segment compared to the HCF segment due to the substantially greater physical properties like optical nonlinearity or Rayleigh backscattering present in SCF. This step leverages the interaction within the SCF segment to gather information usable for monitoring. The analysis performed may use techniques such as LPM, PPE, OTDR, or DAS, depending on the implementation and the physical property.

The method further includes, at 802, determining, from said analysis, a performance characteristic of the optical signal related to its propagation along the transmission path. Because the analysis at 801 is based on the signal's interaction within the SCF segment (which is part of the overall path), the determined characteristic may provide information about the signal, including its passage through the HCF segment(s) where direct monitoring based on these physical properties might be difficult or ineffective. The determined performance characteristic may include, for example, the signal power profile, fiber loss characteristics, PDL, DGD, filtering effects, or localization of phenomena like gas absorption. This determined information can be valuable for assessing signal quality (QoT) and managing the health of the optical link.

In some implementations, such as the fiber level configuration 300, the insertion of SCF segments (e.g., 302) may be incorporated into the transmission path by inserting them directly between HCF segments (e.g., 304, 306). This insertion may be achieved using optical fiber connection techniques, potentially including splicing. Each inserted SCF segment 302 may exhibit physical properties, such as optical nonlinearity or Rayleigh backscattering, which may be used for the analysis performed during monitoring. These properties may be substantially greater in the SCF segment compared to the HCF segments, facilitating the determination of performance characteristics related to the signal's passage through the transmission path, including the HCF segments, based on interactions occurring within the SCF segment itself. Accordingly, these physical properties may exist to a degree that makes the monitoring function possible.

The length of the incorporated SCF segments (e.g., 302, 322, or segments at node 334) can be relatively short, for instance, on the order of tens or hundreds of meters, compared to the length of the HCF segments or spans, which might be tens of kilometers. The specific length required for an SCF segment may depend on factors such as the monitoring technique being employed, the signal-to-noise ratio (SNR) characteristics of the communication system, and the desired spatial resolution for the monitoring results. By using relatively short SCF segments the overall link performance parameters—including added insertion loss, contribution to overall link nonlinearity, or added signal latency—may be kept minimal or negligible. This may allow the system to largely retain the transmission benefits associated with using HCF for the majority of the path length.

In some implementations, to potentially improve monitoring performance or system integration, the SCF segments used may comprise specially designed optical fibers. For example, SCF with enhanced intrinsic optical nonlinearity or enhanced Rayleigh backscattering characteristics (compared to standard single-mode fibers) might be employed, which could potentially improve the sensitivity, accuracy, or range of the corresponding monitoring techniques (e.g., LPM/PPE or OTDR/DAS, respectively). In some implementations, the SCF segment may comprise fibers with a mode field diameter (MFD) selected to substantially match the MFD of the HCF segment to which it connects. Utilizing MFD-matched SCF may facilitate connections with lower splice loss and potentially improve the robustness of the HCF-SCF splice, which can otherwise be challenging.

In some implementations, operational strategies may also be adapted in SCF-assisted HCF systems. Due to the overall low nonlinearity of transmission paths dominated by HCF segments, the constraints imposed by channel interactions like cross-phase modulation (XPM) (which can be limiting in conventional SCF systems) may be relaxed. This could allow for operational modes where one or more designated optical channels are transmitted at a higher power level compared to other data-carrying channels. Propagating such a higher-power signal increases the magnitude of the physical interactions (e.g., nonlinear phase shift) within the short SCF segments, potentially enhancing the accuracy or sensitivity of monitoring techniques like LPM/PPE performed using that channel. This may be achievable without causing substantial detrimental nonlinear interference to neighboring channels due to the low nonlinearity of the HCF segments. Such a higher-power test channel might be employed dynamically when monitoring is performed or could potentially be maintained continuously, for example, for ongoing monitoring or rapid transient fault identification.

Beyond monitoring the quality and performance characteristics related to data transmission, the SCF-assisted approach may be applicable in other applications. For instance, strategically placing SCF segments at specific geographic locations or points of interest (e.g., at intervals corresponding to manholes or access points) within a deployed HCF cable, the setup could potentially be used for distributed fiber sensing applications, detecting disturbances or environmental changes localized to those SCF segments.

The monitoring subsystem or the apparatus configured to perform the monitoring method may be implemented using various hardware architectures. FIGS. 9A, 9B, and 9C illustrate examples of processing system architectures that may be suitable for implementing the processing circuitry and functionalities described herein.

Referring to FIG. 9A, an exemplary apparatus 900 is shown. The apparatus 900 may include processing circuitry, such as at least one processor 910, communicatively coupled via a bus 970 to memory 920 and potentially other components like mass storage 930, an input-output (I/O) interface 940 (e.g., for receiving signal data or outputting results), or a network interface 950. The processor 910 may be a Central Processing Unit (CPU), a Digital Signal Processor (DSP), or other specialized processor. The memory 920 (e.g., Random Access Memory (RAM), Read-Only Memory (ROM), Flash) or mass storage 930 may represent a non-transitory computer-readable medium storing instructions executable by the processor 910 to perform the monitoring analysis and determination steps. Alternatively, the processing circuitry performing these functions may be implemented using Application-Specific Integrated Circuits (ASICs), Field-Programmable Gate Arrays (FPGAs), or other logic circuits.

FIG. 9B illustrates another example apparatus 980, which could be implemented as an integrated circuit or module. The apparatus 980 may include one or more processors 981, an interface circuit 982 (e.g., for signal input/output), and memory 983. The processors 981 (which could include CPUs, DSPs, etc.) may execute instructions stored in memory 983 (e.g., RAM, ROM, Flash) to implement the monitoring operations. The interface circuit 982 facilitates communication or signal transfer relevant to the monitoring function.

FIG. 9C shows a block diagram of another possible configuration 990. This includes a processing unit 992 coupled to a storage unit 991 (e.g., non-transitory memory like RAM, ROM, Flash, registers, cache storing instructions/data) and optionally a communication unit 993 (e.g., for receiving signal data or transmitting results). The processing unit 992, which may comprise one or more processors (e.g., CPU, DSP) or specialized logic circuits (e.g., FPGA, ASIC), is configured, potentially by executing instructions from the storage unit 991, to perform the required analysis based on SCF interactions and determine the performance characteristics.

These architectures 900, 980, 990 are exemplary implementations of processing circuitry suitable for the monitoring subsystem or apparatus. They illustrate that the necessary functions can be carried out by various combinations of processors, memory, interfaces, and potentially specialized hardware or logic circuits configured appropriately.

Some implementations use SCF segments connected in series with HCF segments within an optical transmission path (examples shown in FIG. 3) where analysis based on physical properties of the SCF segments may enable performance monitoring in systems employing HCF. Techniques such as LPM or PPE, when applied within systems that have HCF-in-series-with-SCF structure may allow for distributed monitoring of signal characteristics along the path using only the signal received at a receiver (e.g., Rx 120 in FIG. 1)

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example implementation, should be understood to mean that the value, condition or characteristic is defined within tolerances that are acceptable for the proper operation of the example implementation for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different implementations of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in implementations of this application are used to distinguish between a plurality of objects, and are not used to limit a sequence, a time sequence, priorities, or importance of the plurality of objects.

A person skilled in the art should understand that implementations of this application may be provided as a method, an apparatus (or system), computer-readable storage medium, or a computer program product. Therefore, this application may use a form of a hardware-only implementation, a software-only implementation, or an implementation with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the other programmable device, so that computer-implemented processing is generated. Therefore, the instructions executed on the computer or on another programmable device provide steps for implementing specific functions as described in one or more procedures in the flowcharts and/or one or more blocks in the block diagrams.

Although the present disclosure has been described with reference to specific features and implementations thereof, it is clear that a person skilled in the art can make various modifications and variations to this application without departing from the scope of this disclosure. The specification and drawings are, accordingly, to be regarded simply as an illustration of implementations as defined by the appended claims, and are contemplated to cover any and all modifications, variations, combinations or equivalents that fall within the scope of the present disclosure.

What is claimed is:

1. A fiber optic cable comprising:
a hollow core fiber (HCF) segment; and
a solid core fiber (SCF) segment secured to the HCF segment and optically coupled to the HCF segment, the SCF segment having a material with at least one physical property that causes an optical signal propagating through the material to interact with the material to generate a modified optical signal.

2. The fiber optic cable of claim 1, wherein the at least one physical property of the material includes at least one of:
A) an intensity-dependent refractive index that causes optical nonlinearity;
B) a fluctuation of a density of the material that causes Rayleigh backscattering;
C) a wavelength-dependent refractive index that causes dispersion of the optical signal; and
D) an absorption characteristic of the material that causes attenuation of the optical signal.

3. A fiber optic cable comprising:
a plurality of hollow core fiber (HCF) segments; and
a plurality of solid core fiber (SCF) segments interleaved with the plurality of HCF segments to form a series of alternating HCF and SCF segments, the plurality of HCF segments being secured to the plurality of SCF segments and optically coupled to the plurality of SCF segments.

4. The fiber optic cable of claim 3, wherein the plurality of HCF segments are configured to have an HCF mode field diameter (MFD) and the plurality of SCF segments are configured to have an SCF MFD that substantially matches the HCF mode field diameter.

5. The fiber optic cable of claim 3, wherein:
each HCF segment of the plurality of HCF segments has a respective HCF length,
each SCF segment of the plurality of SCF segments has a respective SCF length, and
the fiber optic cable has a length equal to a sum of the HCF lengths and the SCF lengths.

6. The fiber optic cable of claim 3 further comprising, in at least one SCF segment of the plurality of SCF segments, a respective active optical device.

7. The fiber optic cable of claim 6, wherein the active optical device is an erbium doped fiber amplifier.

8. An optical fiber system, comprising:
a plurality of segments of hollow core fiber (HCF); and
a plurality of solid core fiber (SCF) components interleaved with the plurality of segments of HCF to form a series of alternating segments of HCF and SCF components, the plurality of segments of HCF being fused to the plurality of SCF components and optically coupled to the plurality of SCF components, the plurality of segments of HCF and the plurality of SCF components defining a continuous optical path for light to propagate therethrough.

9. The optical fiber system of claim 8, wherein the plurality of SCF components include at least one of:
segments of SCF;
an electrooptical device having at least one of an input SCF segment and an output SCF segment;
an electromechanical device having at least one of an input SCF segment and an output SCF segment;
a wavelength multiplexing or demultiplexing device having at least one of an input SCF segment and an output SCF segment; and
an optical resonator device having at least one of an input SCF segment and an output SCF segment.

10. The optical fiber system of claim 9, wherein the electrooptical device includes a fiber amplifier.

11. The optical fiber system of claim 9, wherein the electromechanical device is a wavelength selective switch.

12. The optical fiber system of claim 9, wherein the electromechanical device includes a micro-electromechanical system.

13. A method of characterizing the optical fiber system of claim 8, the method comprising:
transmitting a plurality of wavelengths through the optical fiber system along the continuous optical path, the plurality of wavelengths each having associated thereto a same nominal intensity;
selecting a test wavelength from the plurality of wavelengths;
increasing the intensity of the test wavelength to a pre-determined level;
performing a power profile estimation or a longitudinal performance estimation of the optical fiber system, at the test wavelength; and
decreasing the intensity of the test wavelength to the nominal intensity.

14. A method of characterizing the optical fiber system of claim 8, the method comprising:
transmitting a plurality of different wavelengths through the optical fiber system along the continuous optical path, the plurality of wavelengths each having associated thereto a same nominal intensity;
transmitting a test wavelength through the optical fiber system along the continuous optical path, the test wavelength being distinct from the plurality of different wavelengths, the test wavelength having an intensity greater than that of the nominal intensity; and
performing a power profile estimation or a longitudinal performance estimation of the optical fiber system, at the test wavelength.
